(19) United States
(12) Patent Application Publication
(10) Pub. No.: US 2017/0038600 A1
(43) Pub. Date: Feb. 9, 2017

(54) Camera Lens Module With Optical Image Stabilization Function

(71) Applicants: Sul Hyun Hee, Shenzhen (CN); Yang Dea Yue, Shenzhen (CN); Kim Young Jin, Shenzhen (CN)

(72) Inventors: Sul Hyun Hee, Shenzhen (CN); Yang Dea Yue, Shenzhen (CN); Kim Young Jin, Shenzhen (CN)

(73) Assignee: AAC Technologies Pte. Ltd., Singapore city (SG)

(21) Appl. No.: 15/229,190

(22) Filed: Aug. 5, 2016

(30) Foreign Application Priority Data
Aug. 5, 2015 (KR) 10-2015-0110609

(51) Int. Cl. G02B 27/64

(52) U.S. Cl. CPC G02B 27/646

(57) ABSTRACT

An optical anti-shake camera lens module, includes: an optical axis; a housing; at least one lens installed in the housing and moveable relative to the optical axis; an OIS holder moveable along a direction intersecting the optical axis and installed inside the housing; a permanent magnet; an OIS coil (optical image stabilization coil) fixed on an inner wall of the housing and opposite to the permanent magnet; and a number of conductors inside the housing and near the permanent magnet, for generating eddy current along with the movement of the OIS holder and the permanent magnet carried by the OIS holder.

### FIELD OF THE INVENTION

The present invention provides a camera lens module which can reduce instability of the optical image caused by hand shaking.

### DESCRIPTION OF RELATED ART

Recently, portable terminals, not only hand-held camera, but also smart mobile phones, tablets etc., are provided with high performance camera lens module, which have generally auto focusing and optical image stabilization function. Optical image stabilization function is used for reducing the instability of the optical image due to external vibration or user's hand shake. The optical image stabilization function could be achieved by two ways, one of which is “lens moving mode”, in which the lens moves toward the direction crossing the lens optical axis, and another of which is “image sensor moving mode”, in which the image sensor moves toward the direction crossing the lens optical axis. The portable terminal is generally provided with the camera lens module which has optical image stabilization function in lens moving mode.

In general, for camera lens module which has optical image stabilization function in lens moving mode, Hall sensor can perceive the offset of OIS support and the optical axis, input current to OIS coil and prevent the offset of OIS support and optical axis, restore them to their original positions. Such a camera lens module is disclosed in Korean Patent Registration No. 10-1200711.

However, in the camera lens module mentioned above, OIS coil after being electrified will produce specific frequency and create resonance, then OIS coil cannot control the movement of OIS support. For this reason, in order to reduce the adverse impact of resonance on the optical image stabilization function, a suspension wire is installed on FPCB and AF coil in the camera lens module. The suspension wire is coated also with damper bond and the shape and structure of the suspension wire are modified. Moreover, if the suspension wire is not installed in the camera lens module, the shape of the specific part of the camera lens module can be modified or the frictional parts are coated with lubricant.

However, the products are stacked top—down in automatic assembly line, and the operation will be very difficult at the working position with the method above. Moreover, the buffer and lubricant can not be coated automatically at the working position, the coating position and coating amount on the camera lens module with resonance are not same, frequency deviation will increase. As a result, assembling scrap rate of the camera module is higher and the productivity is low.

Therefore, it is necessary to provide an improved camera lens module to overcome above disadvantage.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a camera lens module in accordance with an embodiment of the present disclosure.

FIG. 2 is an exploded view of the camera lens module in FIG. 1.

FIG. 3 is a partial enlarged view of the camera lens module in FIG. 2.

FIG. 4 is a partial enlarged view of the camera lens module in FIG. 2, from another aspect.

FIG. 5 is a front view of an upper leaf spring in the camera lens module in FIG. 2.

FIG. 6 is a top view of the camera lens module.

FIG. 7 is a top view of a camera lens module in accordance with another embodiment.

FIG. 8 is a diagram to explain the effects of the camera lens module in the present invention.

FIG. 9 is a diagram to compare the hysteresis characteristics of previous camera lens module and the camera lens module of the present invention.

FIG. 10 is a diagram to compare the moving tilt characteristics of previous camera lens module and the camera lens module of the present invention.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of present disclosure more apparent, the present disclosure is described in further detail together with the figures and the embodiments. It should be understood the specific embodiments described hereby is only to explain this disclosure, not intended to limit this disclosure.

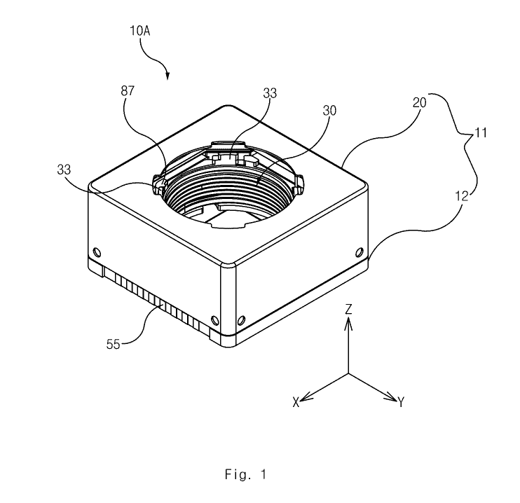

Referring to FIGS. 1-4, the camera lens module 10A of the present invention can be used in portable terminals, such as smart mobile phone, tablets, having auto focusing AF function and optical image stabilization OIS function. The camera lens module 10A includes a housing 11, a lens carrier 30, OIS support 40, permanent magnets 50, an AF coil 39, an OIS coil 52, an FPCB 55, a spacer 130, a lower stopper 57, a lower AF spring 61, a bearing ball 65, an upper leaf spring 70.

The housing 11 includes a base 12, a lens cap 20 connected with the base 12. The base 12 is roughly a square member. A bottom 17 is provided with an opening 13 at a center of the square frame. 4 corners of the bottom 17 are provided with 4 small pillars 15 extending upward. The top ends of 4 small pillars 15 are provided with connecting lugs 16 to connect the spacer 130.

The lens cap 20 includes square upper walls 25. 4 side walls 23 are installed at 4 corners of the square upper walls 25 and bent downward. An opening 21 is provided at the center of the upper wall 25.

The lens carrier 30 is a ring part with an up and down opened aperture 31 at the center thereof, installed inside the housing 11, and is capable of moving up and down along the direction parallel to the optical axis AL. The lens carrier 30 on the outer circumferential surface 32 is wrapped by the AF coil 39.

The OIS support 40 is a square frame component wrapping the lens carrier 30. 4 square corners are provided with 4 legs 41 extending downward. The OIS support 40 supports the lens carrier 30 and can move up and down along the direction parallel with the optical axis AL. The OIS support 40 is installed inside the housing 11 in the direction crossing the optical axis AL and can move along the direction parallel with XY planes.

The lower stopper 57 is a square part and forms an aperture 58 where the optical axis AL can pass through, installed between the bottom 17 of the base 12 and the lens carrier 30 to limit the extent of the downward movement when the lens carrier 30 moves down in a direction parallel to Z plane. The lower stopper 57 is fixed on the bottom 17 of the base 12. The downward connecting lugs on 4 legs 41 of OIS support 40 are inserted into the connection groove 59 at 4 corners of the lower stoppers 57. The lower stopper 57 is connected to the OIS support 40.

4 permanent magnets 50 are inserted between 2 legs 41 adjacent to the OIS support 40 and fixed on the OIS support 40. 4 permanent magnets 50 are placed inside the housing 11 and located at the position relative to 4 side walls 23 of the lens cap 20. 4 OIS coils 52 are fixed on the internal side of 4 side walls 23 of the lens cap 20 and placed at the position relative to 4 permanent magnets 50. Specifically, the FPCB 55 is fixed on the inner side of the side wall 23. 4 OIS coils 52 are fixed on FPCB 55. The OIS coil 52 and the FPCB 55 are connected electrically.

The OIS coil 52 is made by copper or copper alloy wires. The external surface is coated with insulation coating for insulation. The coil in the direction parallel to XY planes shall be longer and the coil in the direction parallel to Z axis shall be shorter and some of the coil area is in ring shape. On the FPCB 55, for measuring the position of the OIS support 40 and the lens [not shown], a pair of hall sensors 54 is provided. The pair of hall sensors 54 is placed in the middle of the ring OIS coil 52.

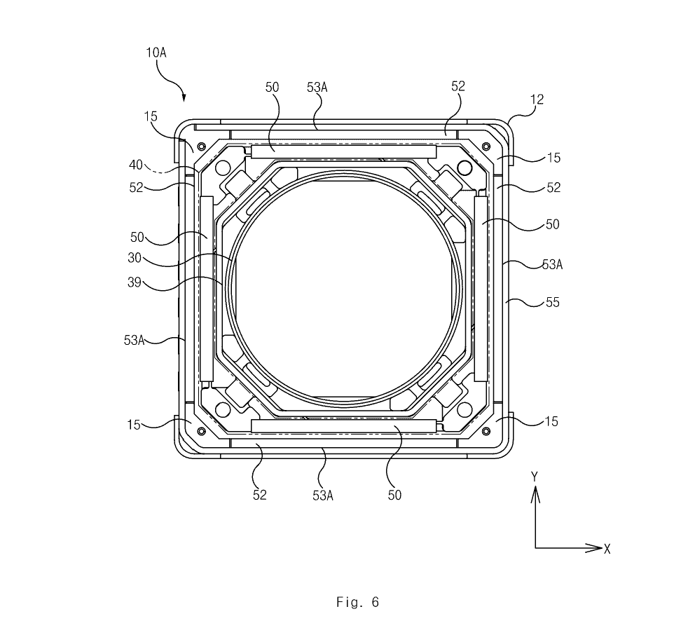

The camera lens module 10A inside the housing 11 is aligned with the 4 permanent magnets 50 and 4 conductors 53A. The conductors 53A are made by metal film and stuck respectively on the side of the FPCB 55 opposite to the 4 OIS coils 52 [see FIG. 6]. As mentioned above, because the OIS coil 52 external surface is insulated, the OIS coil 52 and the conductors 53 are isolated from each other.

The conductors 53A are made by ring metal films and overlapped with the ring OIS coil 52. The thickness can be from 0.02 mm to 0.1 mm.

When transferring current to the OIS coil 52, the electromagnetic force is produced by the permanent magnets 50. When the permanent magnets 50 fixed on the OIS support 40 and the coil move, a directive force is produced on the conductors 53 and interferes the movement of the permanent magnets 50, creating eddy current. As mentioned above, the phenomenon that eddy current suppressing the relative movement between the magnets and conductor is called as eddy current damping or eddy current brake. Eddy current damping force F is the arithmetic product between the magnetic density B and the relative speed v between the magnet and the conductor, which satisfies the following expression:

Because the eddy current produced on the conductor 53A is very weak, the area of the conductor 53A is not required to be too large and the thickness is not required to be very big. Therefore, the conductors 53A are ease of processing, avoiding damage. To ensure the camera lens module 10A to be compact, the conductors are made as much as possible to be small and thin, Moreover, the conductors 53A are fixed firmly on the side of the OIS coil 52. To avoid the influence on the perceptual performance of the hall sensors 54 placed in the middle of the OIS coil 52, the conductors are configured into a ring and are overlapped with the ring OIS coil 52.

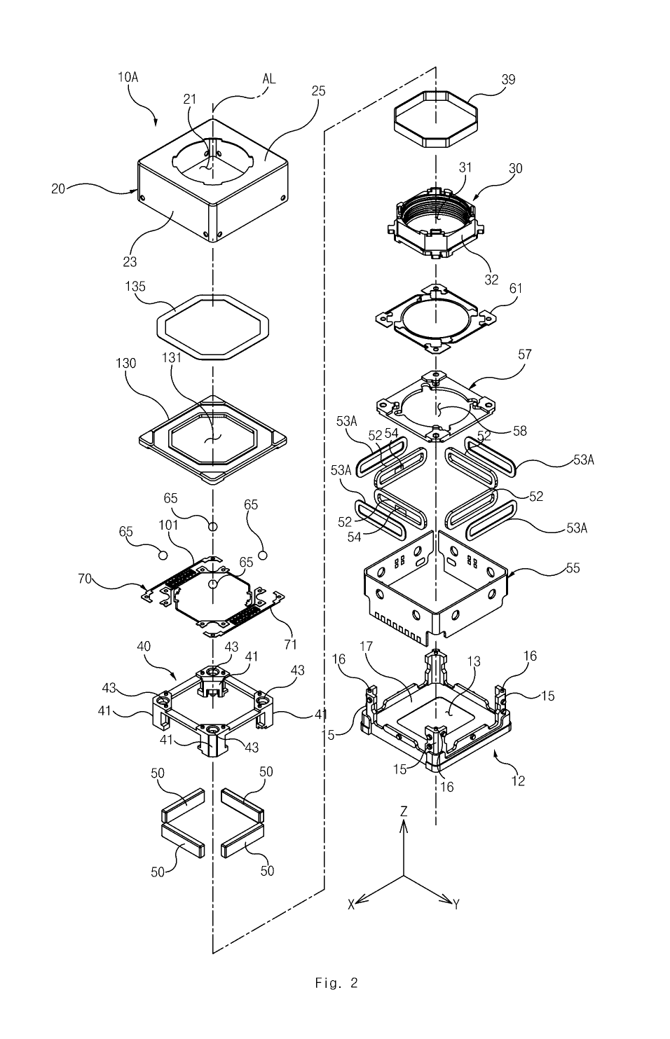

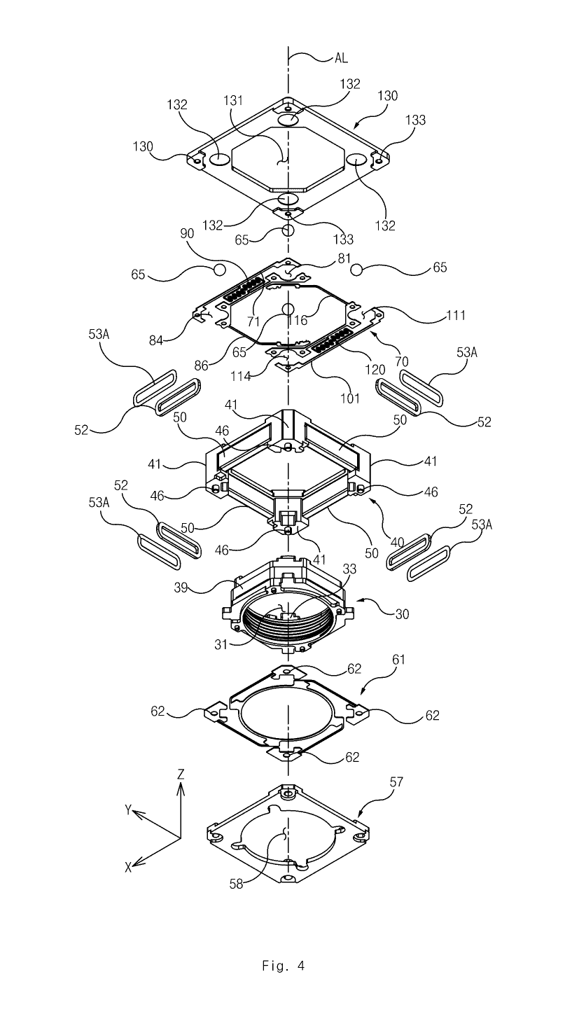

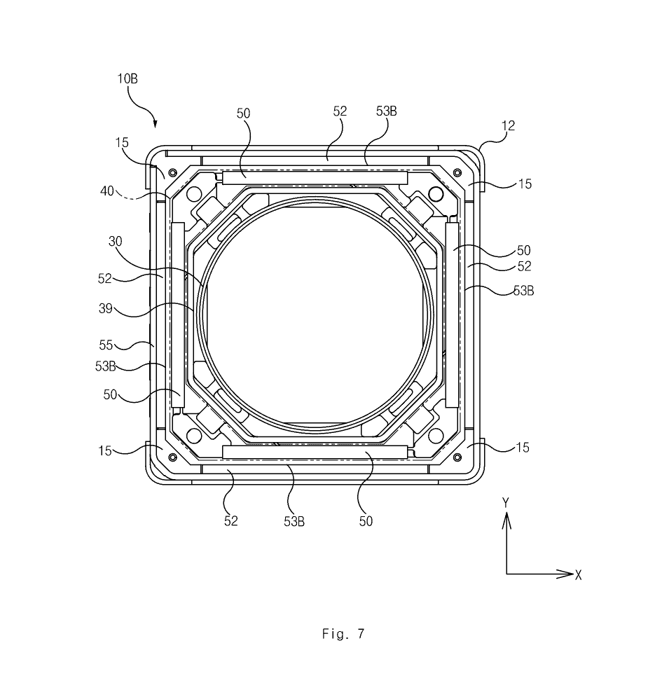

Refer to FIG. 7, in other embodiment of the present invention, the camera lens module 10B is provided with 4 conductors 53B. 4 conductors are stuck respectively on the side of the magnets 50 opposite to 4 OIS coils 52. The material, shape, size and thickness of the conductor 53B are as same as the conductor 53A in FIG. 2 and FIG. 4, just stickup position is different. If the conductor 53B shown in FIG. 7 are electrically connected to OIS coil 52, the permanent magnets 50 and OIS support 40 move, the eddy current will be produced on the conductor 53B, creating buffering effect thereby.

Referring to FIG. 1 and FIG. 4 again, the lower part of FPCB 55 on one side is exposed outside the housing 11, and connected with the power supply line [not shown] outside the housing 11. The upper leaf spring 70 is made by electro conductive material as same as metal. Moreover, the electrode and conductive layer are formed within the upper leaf spring 70. The electric wire is made by non-metallic elastic material. The housing mounting portion 72,102 of the upper leaf spring 70 is electrically connected to FPCB 55. The end of AF spring portion 86,116 of the upper leaf spring 70 is electrically connected to the end of AF coil 39. The structure is as same as this structure. The electric current outside the housing 11 can be transferred to OIS coil 52 through FPCB 55. The electric current can be transferred to AF coil 39 through FPCB 55 and the upper leaf spring 70.

Moreover, the lens carrier 30 of the camera module 10A can be stacked in turn with OIS support 40 and the upper leaf spring 70. Such a structure can transfer electric current to AF coil 39 through the upper leaf spring 70. It is not necessary to install the wiring part which influences the assembling of the camera lens module 10A, such as suspension wire.

Therefore, the assembling of the camera lens module 10A can be easily, improving productivity.

The spacer 130 is a square frame component with an opening in which the optical axis AL can pass through. The spacer is installed between the inner side of the upper wall 25 of the cover 20 and the upper leaf spring 70. The lower side of 4 corners of the spacer 130 is provided with groove 133 connected with the base. The connecting lugs 16 at the upper end of four pillars 15 of the base 12 are inserted on four connecting grooves 133. The spacer 130 is fixed on the base 12 and provided with a yoke 135 assembled with magnets. The magnets 50 installed on OIS support 40 produce attractive force to the yoke 135. Therefore, the ball bearing 65 is put between the spacer 130 and OIS support 40 close each other.

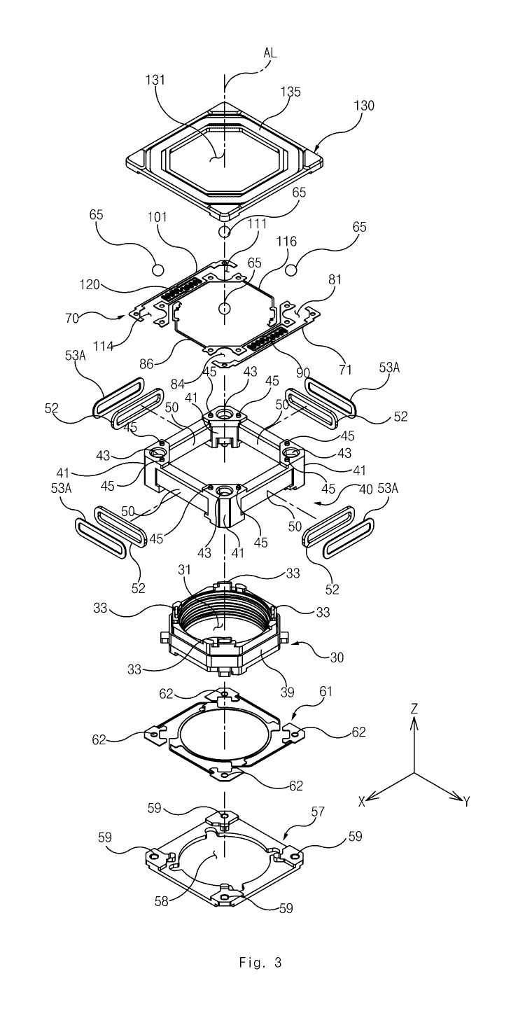

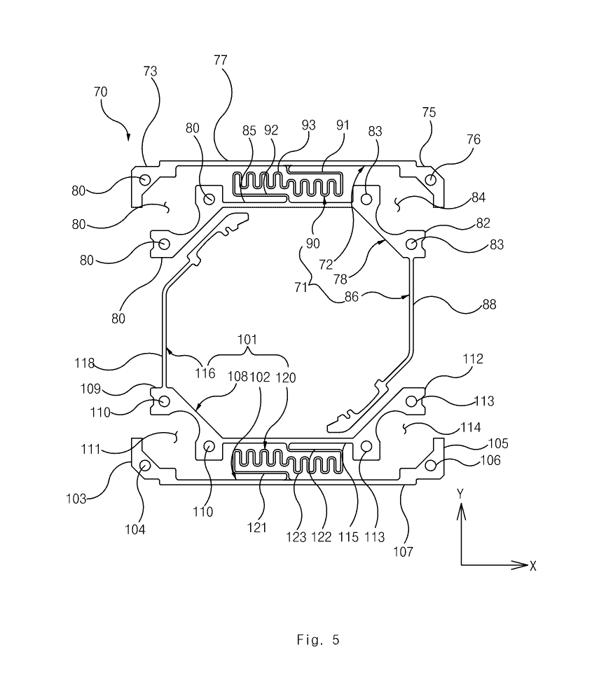

Referring to FIG. 3 and FIG. 5, in the housing 11 [see FIG. 1], the upper leaf spring 70 is placed at the lower part of the spacer 130 and the upper end of OIS support 40, and symmetrical to the lens optical axis AL, divided into the first leaf spring and second leaf spring 71,101. The first and the second leaf springs 71,101 include respectively the housing mounting portion 72,102 on the housing 11, OIS support mounting portion 78 on OIS support 40, AF spring portion 86,116 extended by OIS support mounting portion 78,108 pressing the lens carrier 30 in the direction parallel to the optical axis AL, connecting spring portion 90,120 connecting the housing mounting portion 72,102 and OIS support mounting portion 78,108.

The housing mounting portion 72,102 is fixed on the base 12 and includes the first 1 and second outside ends 73,75,103,105 which are disconnected, and the outer side connecting beams 77,107 connected to the first and second outside ends 73,75,103,105. OIS support mounting portion 78,108 is fixed on OIS support 40, the first and second inside ends 79, 82,109,112 which are disconnected, and the inside connecting beams 79, 82,109,112 connected to the first and second inside ends 85,115.

Specifically, the connection holes 74, 76, 104, 106 are formed on the first outside end 73,103 and the second outside end 75,105. The connecting lugs 16 [see FIG. 2] on the upper end of the base pillars 15 [see FIG. 2] are inserted into the connecting holes 74,76,104,106 and inserted into the connection grooves 133 connected to the spacer 130. The first outside end 73,103 and the second outside end 75,105 are connected firmly on the base 12 see FIG. 2. Moreover, one pair of connection holes 80, 83,110,113 are formed respectively on the first inside end 79,109 and the second inside end 82,112. One pair of the connecting lugs 45 formed on four legs 41 of OIS support 40 are inserted into the connection holes 80, 83, 110, 113 on the inside ends. The first inside end 79,109 and the second inside end 82, 112 are fixed on the OIS support 40.

The connecting spring portion 90,120 is inserted between the outside end connecting beam 77,107 and inside end connecting beam 85,115. The connecting spring portion 90,120 is provided a zigzag spring portion 93,123 extended in zigzag mode. The outside end connecting beam 77,107 is extended parallel in length direction and connected with “1” shaped side connection beam 77,107. Other side ends are connected with the first straight spring portion 91,121 at the “1” shaped side end of the zigzag spring portion 93,123. The inside end connecting beam 85,115 is extended parallel in length direction. The “1” shaped side end is connected with the inside end connecting beam 85,115 and other side ends are connected with the second straight spring portion 92,122 at other side end of the zigzag spring portion 93,123.

As shown in FIG. 5, “1” shaped side of zigzag spring portion 93,123 overlapped with the first straight spring portion 91,121 is installed in tilt on the inside upper end connecting beam 85,115 and other side of zigzag spring portion 93,123 overlapped with the second straight spring portion 92,122 is installed at tilt on the outside end connecting beam 77,107. The spring portion 90,120 connected in such a structure takes minimum space between the outside end connecting beam 77,107 and inside end connecting beam 85,115, so the assembly is compact.

Zigzag spring portion 93,123, shown in FIG. 5, can be expanded in zigzag mode along the direction vertical to the length direction of the outside end connecting beam 77,107 and inside end connecting beam 85,115. On the contrary, Zigzag spring portion 93,123 can be expanded also in zigzag mode along the direction in parallel to the length direction of the outside end connecting beam 77,107 and the inside end connecting beam 85,115, expanded along the direction vertical to the length direction of the outside end connecting beam 77,107 and the inside end connecting beam 85,115.

When the OIS support 40 moves at the direction crossing the optical axis AL, the connecting spring portion 90,120 guides the moving route and limits the scope of its movement. Moreover, OIS support 40 moves at the direction crossing the optical axis AL, if out of the default position, the connecting spring portion 90,120 may apply elastic force on OIS support 40, in aid of restoring OIS support 40 to the default position.

The AF spring portion 86,116 is provided with end portions 87,117 connected with the upper end of the lens holder 30 and connected with the inside end 82,109 of OIS support mounting portion 78,108 and the inside end connecting beam 88,118 at the end portion 87,117. Moreover, several connecting lugs 33 are formed upward at the upper end of the lens holder 30. The end portion 87,117 of AF spring portion 86,116 is inserted into two of the connecting lugs 33. The end portion 87,117 applies elastic force to squeeze the surround area of the connecting lugs 33.

On the one hand, in the housing 11 [see FIG. 1], the lower AF spring 61 is installed above the lower stopper 57 and underneath the lens carrier 30 and applies upward the elastic force on the lens carrier 30. Four connecting lugs 46 at the lower end of 4 legs 41 of OIS support 40 pass through the lug holes 62 formed on four corners of the lower AF spring 61 and inserted into four raised connecting grooves 59 of the stopper 57 .

When the AF coil 39 is electrified to produce electromagnetic force and the lens carrier 30 and the optical axis move parallel to the auto focusing position or the original position, the lower AF spring 61 applies upward the elastic force on the lens carrier 30. AF spring portion 80 applies downward the elastic force on the lens carrier 30 to help the movement of the lens carrier 30.

4 bearing balls 65 are installed between OIS support 40 and spacer 130 to reduce the friction force produced by OIS support 40 when it moves in the direction crossing the optical axis AL. To prevent 4 bearing balls 65 off from the default position, the installing grooves 43 are formed on the upper side of 4 corners of OIS support 40 to install respectively the upper portion of 4 bearing balls 65. Moreover, the installing grooves 132 are formed on the lower side of 4 corners of the spacer 130 to install the upper portion of 4 bearing balls 65. Bearing balls 65 installed on the upper end mounting grooves 132 can roll along the direction vertical to the optical axis AL. The inner diameter of the upper mounting groove 132 for the bearing ball is larger than the diameter of the bearing ball 65.

The length of the lower end mounting groove of the bearing ball 43 and the upper end mounting groove of the bearing ball 132 is larger than their width, and they are not extended along with the I-shape direction nor the perpendicular direction. Therefore, when the OIS coil 52 (refer to FIG. 2) is electrified, the electromagnetic force is exerted on the OIS support 40, and when it is moving in direction crossing the optical axis AL, the OIS support 40 will move to the destination along with the specialized direction instead of moving in a round-about way, it will move rapidly along with the shortest routine to the destination.

On the one hand, on the upper leaf spring 70, 4 bearing balls 65 pass through the upper leaf string 70 and they are installed on the lower end mounting groove 43 of bearing balls of the OIS support 40, and thus will form the accommodation spaces 81, 84, 111, 114 of bearing balls with the same number as that of the bearing ball 65.

Referring to FIGS. 1 and 5, In order to present the function of automatic focusing, the camera lens module 10A will have the following actions. When the AF coil 39 is electrified, the electromagnetic force is generated between the permanent magnet 50 and the AF coil 39; inside the housing 11, the lens carrier 30 will move up or down at the default level in the status that the OIS support 40 is fixed, and it will move to the level of lens focusing. The level of the lens carrier 30 with lens focusing is the position where the balance is formed between the electromagnetic force exerting to the lens carrier 30 winded with the AF coil 39 and the elasticity of AF spring portion 86, 116 and the lower AF spring 61. On the other hand, when the photos have been taken or when the functions of camera have been closed, the current of the AF coil 39 decreases, and the lens carrier 30 will be affected by the elastic force of AF spring portion 86, 116 and the lower AF spring 61 and it will restore to the standard location.

In order to present the function of image stabilization, the actions of the camera lens module 10A are as follows: via the gyro sensor of the portable terminals [not shown] installed on the camera lens module 10A, the vibration of the portable terminals caused by the hand shaking can be sensed, OIS coil 52 is electrified, and the electromagnetic force is generated between the permanent magnet 50 and OIS coil 52, inside the housing 11, the OIS support 40 and the lens carrier 30 fixed on the OIS support will move from the default position towards the direction crossing the optical axis AL, i.e., it will move in parallel with XY plane and move to the position where the image sensor not implied in the Fig. senses the vibration of the image. This changing location is a position where the balance is formed between the electromagnetic force exerting on the OIS support 40 and the elastic force of connecting spring portion 90, 120. On the other hand, when the portable terminal's vibration is caused by the hand shaking is terminated, the current flowing to the OIS coil 52 will decrease, and the OIS support 40 and the lens carrier 30 fixing it will be affected by the elastic force of connecting spring portion 90, 120 and restore to the standard location.

When the Hall sensor 54 senses the position of the OIS support 40 on the XY plane, in order to move the OIS support 40 toward the position of the sensed image shaking or in order to restore OIS support to the standard position, the proper current will flowed to the OIS coil 52 so as to help the OIS support 40 restore to the standard position.

As per the stabilization function, if OIS support 40 deviates from the standard position, OIS support mounting portion 78,108 connected to OIS support 40 and OIS support 40 will move in XY plane in parallel, and the connecting spring portion 90, 120 get deformed to restore. Afterwards, if there is no shake or the shooting is completed, the connecting spring portion g 90, 120 will restore to the original shape, and OIS support mounting portion 78,108 and OIS support 40 connecting to OIS support mounting portion will restore their standard positions.

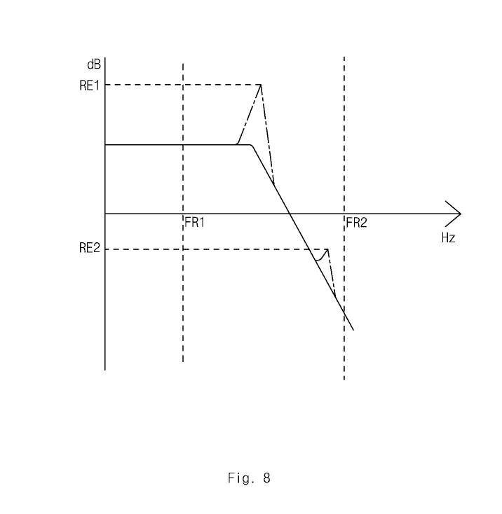

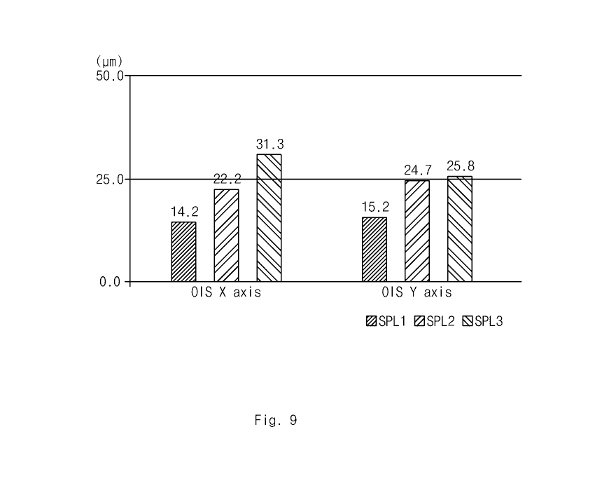

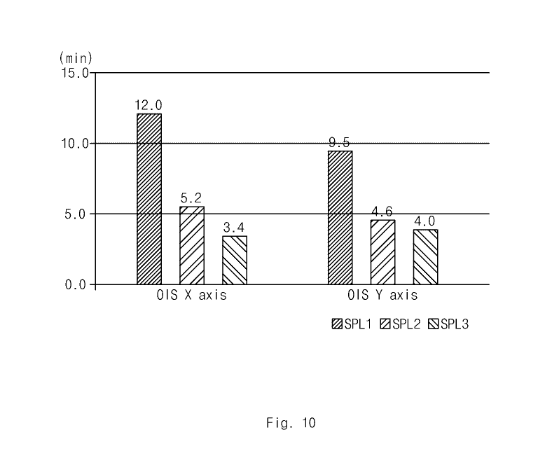

FIG. 8 is a diagram indicating the result of the camera lens module in this invention, and FIGS. 9 and 10 are diagrams to compare the characteristics of previous camera lens module and the camera lens module of the present invention. FIG. 9 is the diagram to explain the hysteresis characteristics. FIG. 10 is the diagram to explain the moving tilt characteristics.

In order to move the OIS support 40 fixing the permanent magnet 50 towards the stabilization position, while OIS coil 52 is being electrified, the vibration frequency produced by the stabilization will increase, and offset the vibration frequency accordingly, and the current frequency of the input OIS coil 52 will increase, and the current frequency of the input OIS coil 52 can be the frequency within FR1 and FR2. For example, the frequency in lower limit is FR11 Hz, and the frequency in upper limit can be FR2 10KHZ.

However, for the camera lens module without mounting the conductor 53A, 53B, under the specific frequency in the range between the frequency in the lower limit FR1 and the frequency in the upper limit FR2 mentioned above, the vibration of OIS support 40 will increase sharply, and form one resonance RE1 and two resonances RE2. Therefore, if there is one resonance RE1 and/or two resonances RE2, the stabilization can't control the movement of OIS support 40. However, present camera lens module 10A, 10B with the conductor 53A, 53B installed will produce the eddy current resistance result, and move towards the resonance point, and make OIS support 40 will not have the resonance in the range between the frequency in the lower limit FR1 and the frequency in the upper limit FR2 mentioned above. Then, the stabilization function can make the movement of OIS support 40 reliable, which can be controlled in safer manner.

FIGS. 9 and 10 are diagrams to explain the result of testing the camera lens module, and SPL1 is the result of testing the camera lens module without mounting the conductor, like shown in FIG. 6, SPL2 is the result of the camera lens module 10A with its conductor 53A mounted between OIS coil 52 and FPCB55, like shown in FIG. 7, SPL3 is the result of the camera lens module 10B with its conductor 53B mounted between permanent magnet 50 and OIS coil 52.

The hysteresis shown in FIG. 9 refers to the maximum difference between the displacement of OIS support with the increase of the current entering into OIS coil and the displacement of OIS support with the decrease of the current entering into OIS coil. Here, OIS X axis refers to the displacement difference towards the direction parallel to X axis, and OIS Y axis refers to the displacement difference towards the direction parallel to Y axis. As shown in FIG. 9, comparing with the camera lens module without being mounted with the conductor, the hysteresis value of the camera lens module 10A, 10B mounted with the conductor 53A, 53B is much better, that is because of the eddy current resistance result produced by the conductor 53A, 53B. Therefore, the current frequency input to OIS coil can relieve the resonance, and control the movement of OIS support, and play the role of stabilization.

The moving tilt shown in FIG. 10 result refers to the tilted angle produced by OIS support with the current entering into OIS coil, and its unit is min, and 1 min is 1/60°. Here, OIS X axis revolves around the axis parallel to X axis, and produces the tilted angle, and OIS Y axis revolves around the axis parallel to Y axis, and produces the tilted angle. As shown in FIG. 10, comparing with the camera lens module without being mounted with the conductor 53A, 53B, and the moving tilt value of the camera lens module 10A, 10B mounted with the conductor 53A, 53B is smaller. While OIS support is electrified, the swing and tilt of OIS support is very little, based on the current entering into OSIS coil, OIS support can move reliably.

In one aspect, the present invention is not limited to the embodiments illustrated with reference to the figures. For example, the OIS coil can be fixed on the OIS holder, permanent magnet can be fixed on the inner side of the housing. Furthermore, the conductor can be adhered and fixed to the linear side and other sides of the OIS coil. Besides, the conductor is not adhered to the side of the OIS coil, but can be spaced apart from the OIS coil by a little distance, to be distributed separately.

The description is only made with reference to the embodiment of the present invention shown in the figures, which shall only be taken as exemplary. It should be noted that those skilled in the technical field may understand modifications of the examples and understand the same other embodiments. Therefore, the real protection range of the invention is only provided according to the appended patent claims.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. An optical anti-shake camera lens module, comprising:
an optical axis;
a housing;
at least one lens installed in the housing and moveable relative to the optical axis;
an OIS holder moveable along a direction intersecting the optical axis and installed inside the housing;
a permanent magnet;
an OIS coil (optical image stabilization coil) fixed on an inner wall of the housing and opposite to the permanent magnet;
a plurality of conductors inside the housing and near the permanent magnet, for generating eddy current along with the movement of the OIS holder and the permanent magnet carried by the OIS holder.

2. The optical anti-shake camera lens module as described in claim 1, wherein an outer peripheral surface of the OIS coil is insulated.

3. The optical anti-shake camera lens module as described in claim 2, wherein the OIS coil is wound into a ring shape, and the conductor is made of a metal thin film overlapped with the ring shape of the wound OIS coil.

4. The optical anti-shake camera lens module as described in claim 2, wherein the conductor includes non-magnetic substance.

5. The optical anti-shake camera lens module as described in claim 4, wherein the conductor is composed by copper (Cu) or copper-containing alloy.

6. The optical anti-shake camera lens module as described in claim 2, wherein the conductor has a thickness from 0.02 to 0.1 mm.

7. The optical anti-shake camera lens module as described in claim 2, further including an AF coil wound on the outer circumferential surface of the lens carrier; an FPCB fixed on the inner side of side wall of the housing for supplying power to the AF coil and the OIS coil; an upper plate spring inside the housing and installed at an upper part of the OIS holder.
